(19) United States
(12) Patent Application Publication
(10) Pub. No.: US 2025/0056173 A1
(43) Pub. Date: Feb. 13, 2025

(54) LEAKAGE PATH DETECTION IN ACOUSTIC SENSOR MODULES

(71) Applicant: Soundskrit Inc., Montreal (CA)

(72) Inventors: Ravi Patel, Montreal (CA); Carly Stalder, Montreal (CA); Stephane Leahy, Montreal (CA)

(21) Appl. No.: 18/797,363

(22) Filed: Aug. 7, 2024

Related U.S. Application Data
(60) Provisional application No. 63/531,407, filed on Aug. 8, 2023.

(51) Int. Cl. H04R 29/00; G01M 3/02; H04R 1/04; H04R 1/34; H04R 19/04

(52) U.S. Cl. CPC H04R 29/004; G01M 3/02; H04R 1/04; H04R 1/342; H04R 19/04; H04R 2201/003

(57) ABSTRACT

An acoustic sensor module includes an acoustic sensor device including a transducer and an enclosure configured to encapsulate and seal the acoustic sensor device within the enclosure. The enclosure includes a first sound port configured to couple a first side of the transducer to an embodiment environment via a first acoustic channel formed in the enclosure. The enclosure also includes a second sound port configured to couple a second side of the transducer to the embodiment environment via a second acoustic channel formed in the enclosure. The enclosure additionally includes a notch formed on a surface of the enclosure. The notch is configured to enable detection of a leakage path, within the enclosure, between the first sound port and the second sound port around an outside of the acoustic sensor device.

### CROSS-REFERENCES TO RELATED APPLICATIONS

This application claims the benefit of U.S. provisional application entitled “Acoustic Leak Detection,” filed Aug. 8, 2023, and assigned Ser. No. 63/531,407, the entire disclosure of which is hereby expressly incorporated by reference.

### BACKGROUND OF THE DISCLOSURE

### Field of the Disclosure

The disclosure relates generally to acoustic sensor devices such as microelectromechanical system (MEMS) microphones.

### Brief Description of Related Technology

Traditional omnidirectional acoustic sensor devices (e.g., omnidirectional microphones) measure the pressure of incoming sound. A transducer, or membrane, that moves in response to the incoming sound is encapsulated in a package. The transducer partitions the package into two air volumes, a front air volume and a back air volume. The package has a sound port that couples one of the air volumes to the outside ambient environment (e.g., ambient air). As sound hits the acoustic sensor device, the sound couples into one of the air volumes through the sound port and changes the pressure. This creates a difference in pressure between the front air volume and the back air volume that creates a force on the transducer and drives its motion. In this configuration, the omnidirectional acoustic sensor device responds equally to sound travelling at all directions.

Directional acoustic sensor devices (e.g., directional microphones), on the other hand, use two sound ports, exposing each opposing side of the transducer to the ambient environment. Directional acoustic sensor devices are configured to sense a pressure gradient between the two sound ports. Directional acoustic sensor devices are thus designed to have a high sensitivity to sound travelling in one direction and low sensitivity to sound travelling in another direction. Directionality allows the acoustic sensor to separate sound sources.

When integrating acoustic sensor devices inside of electronic device products, it is useful to ensure that the acoustic sensor device has good sealing inside of the product. Improper sealing can compromise the performance of the acoustic sensor device. Typical leakage detection techniques to test whether an acoustic sensor device is properly sealed in a product may involve measuring an output signal of the acoustic sensor device while covering sound ports in the product to determine whether sound waves are still coupling into the acoustic sensor device when the sound ports are covered. However, with directional acoustic sensor devices, if there is improper sealing, a leakage path between the two sound ports of the acoustic sensor device may occur internally to the product. Such internal leakage path may be undetected by the typical leak detection techniques.

### SUMMARY OF THE DISCLOSURE

In accordance with one aspect of the disclosure, an acoustic sensor module includes an acoustic sensor device including a transducer, and an enclosure configured to encapsulate and seal the acoustic sensor device within the enclosure. The enclosure includes a first sound port configured to couple a first side of the transducer to an embodiment environment via a first acoustic channel formed in the enclosure. The enclosure also includes a second sound port configured to couple a second side of the transducer to the embodiment environment via a second acoustic channel formed in the enclosure. The enclosure additionally includes a notch formed on a surface of the enclosure. The notch is configured to enable detection of a leakage path, within the enclosure, between the first sound port and the second sound port around an outside of the acoustic sensor device.

In accordance with another aspect of the disclosure, an acoustic sensor module includes an acoustic sensor device including a transducer and a gasket configured to encapsulate and seal the acoustic sensor device within the gasket. The gasket includes a first sound port configured to couple a first side of the transducer to an embodiment environment via a first acoustic channel formed in the gasket. The gasket also includes a second sound port configured to couple a second side of the transducer to an embodiment environment via a second acoustic channel formed in the gasket. The gasket additionally includes one or more notches formed on a surface of the gasket, the one or more notches configured to enable detection of one or more leakage paths, within the gasket, between the first sound port and the second sound port around one or more sides of the acoustic sensor device.

In connection with any one of the aforementioned aspects, the devices and/or methods described herein may alternatively or additionally include or involve any combination of one or more of the following aspects or features. The notch is configured to extend into the enclosure such that the notch in the enclosure is spaced from a package of the acoustic sensor device by a set distance. The set distance is configured to enable detection of a leakage path that is equal to or greater than a length of the set distance. The notch is configured to extend through the enclosure to reach a package of the acoustic sensor device. The notch is a first notch formed on a first side of the enclosure and configured to enable detection of the leakage path around a first side of the acoustic sensor device. The enclosure further includes a second notch formed on a second side of the enclosure and configured to enable detection of another leakage path around a second side of the acoustic sensor device. The first acoustic channel and the second acoustic channel are bent and diagonally disposed within the enclosure such that the first sound port and the second sound port are formed on a same side of the enclosure. The enclosure comprises a gasket. The gasket is configured to seal the acoustic sensor device by one or both of i) compression between the gasket and the acoustic sensor device and ii) an adhesive between the gasket and the acoustic sensor device. The gasket includes a combination of one or more of a rubber material, a foam material, an adhesive, or plastic. The notch comprises a cutout in the gasket. The gasket comprises two separate gasket parts. The notch is formed at a junction between the two separate gasket parts. The notch is a first notch formed at the junction between the two separate gasket parts on a first side of the acoustic sensor device and configured to enable detection of the leakage path around the first side of the acoustic sensor device. The enclosure further comprises a second notch formed at the junction between the two separate gasket parts on a second side of the acoustic sensor device and configured to enable detection of another leakage path around the second side of the acoustic sensor device. The notch is configured to be filled after leak detection is performed and before the acoustic sensor module is integrated into an end product device. The transducer comprises a microelectromechanical system (MEMS) transducer. The acoustic sensor device comprises a microelectromechanical system (MEMS) microphone. The one or more notches comprise one or more cutouts in the gasket. The one or more notches are configured to extend into the gasket such that the one or more notches in the gasket are spaced from a package of the acoustic sensor device by a set distance, wherein the set distance is configured to enable detection of a leakage path that is equal to or greater than a length of the set distance. The one or more notches include a first notch formed at the junction between the two separate gasket parts on a first side of the acoustic sensor device and configured to enable detection of a first leakage path around the first side of the acoustic sensor device. The one or more notches also include a second notch formed at the junction between the two separate gasket parts on a second side of the acoustic sensor device and configured to enable detection of a second leakage path around the second side of the acoustic sensor device.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 depicts a cross-sectional view of a gasket for a directional acoustic sensor module with a built-in leakage detection feature in accordance with an example.

FIG. 2 depicts a cross-sectional view of a directional acoustic sensor device and gasket module with a built-in leakage detection feature in accordance with an example.

FIG. 3 depicts a cross-sectional view of a directional acoustic sensor device and gasket assembly with a leakage path in accordance with another example.

FIG. 4 depicts a top view of an acoustic sensor module having a two-piece gasket with an embedded leak detection feature in accordance with an example.

FIG. 5 depicts a cross-sectional view of an acoustic sensor module having a two-piece microphone gasket with an embedded leak detection feature in accordance with another example.

FIG. 6 is a cross-sectional, schematic view of a directional acoustic sensor device, according to an example.

The embodiments of the disclosed devices may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

As discussed above, improper sealing of an acoustic sensor device, such as a microphone, integrated inside a product may compromise the performance of the acoustic sensor device. Improper sealing may adversely affect the sensitivity and frequency response of the acoustic sensor device. Improper sealing may also make the acoustic sensor device susceptible to picking up sources of noise internal to the product, such as a loudspeaker. In connection with directional acoustic sensor devices, improper sealing of the acoustic sensor device in the product may also compromise the directionality of the acoustic sensor device, making the acoustic sensor device deviate from a desired directivity pattern.

To test whether an acoustic sensor device is properly sealed in a product, a sound is typically played external to the product and the output signal of the acoustic sensor device in the product is measured with sound port(s) in the product uncovered and covered (e.g., with clay, putty, or tape). If the acoustic sensor device is properly sealed within the product, then when the sound port(s) are covered, the output signal of the acoustic sensor device is greatly reduced compared to when the sound port(s) are uncovered, because proper sealing of the acoustic sensor device ensures that if the sound port(s) of the acoustic sensor device are closed, then sound cannot couple into the acoustic sensor device. If the acoustic sensor device is not properly sealed, even with the sound port(s) covered, there is a leakage path in which the external sound can get into the acoustic sensor device. As a result, the output signal of the acoustic sensor device with the sound port(s) uncovered and covered has less of a difference than in the case when the acoustic sensor device is properly sealed.

Omnidirectional acoustic sensor devices have only one sound port in the acoustic sensor device. If there is improper sealing, a leak may occur at the interface between enclosure (e.g., gasket) that seals the acoustic sensor device and the enclosure of the product. Unlike omnidirectional acoustic sensor devices, directional acoustic sensor devices have two sound ports. This creates an additional potential leakage path due to improper sealing. The acoustic sensor device may exhibit a leakage path between the interface of the enclosure (e.g., gasket) that seals the acoustic sensor device and the product enclosure at either of the two sound ports, but also may see a leakage path between its two sound ports, completely internal to the product. In this scenario, previous leak detection techniques may not be capable of detecting when this leakage path exists.

Disclosed are acoustic sensor modules having an enclosure (e.g., a gasket) that seals an acoustic sensor device, with a notch or cutout formed in the enclosure for acoustic leak detection. The enclosure (e.g., the gasket) may be configured for leak detection in connection with directional acoustic sensor devices. The notch or cutout may be configured to support testing for the presence of a leakage path between two sound ports of the directional acoustic sensor device. In an example, an acoustic sensor module may include an acoustic sensor device including a transducer, and an enclosure configured to encapsulate and seal the acoustic sensor device within the enclosure. The enclosure may include a first sound port configured to couple a first side of the transducer to an embodiment environment via a first acoustic channel formed in the enclosure and a second sound port configured to couple a second side of the transducer to the embodiment environment via a second acoustic channel formed in the enclosure. The enclosure may also include a notch or cutout formed on a surface of the enclosure. The notch or cutout may be configured to enable detection of a leakage path, within the enclosure, between the first sound port and the second sound port around an outside of the acoustic sensor device.

As described herein, the notch or cutout may have a depth that establishes a threshold at which a leakage path is deemed to be problematic. For instance, a gap between the acoustic sensor device housing and the gasket of less than 0.3 mm may be acceptable. A gap equal to or greater than 0.3 mm may be unacceptable, and the depth of the notch may be configured accordingly to detect gaps of such size. Alternatively, the notch or cutout may extend to, or reach, a housing of the acoustic sensor device. For example, a two-piece gasket may form a notch at the interface of the two pieces that reaches the housing of the acoustic sensor device.

In some cases, the notch or cutout in the enclosure (e.g., the gasket) may be filled or otherwise covered after testing (e.g., of a module or a sub-assembly) and before assembly of the end product. Alternatively or additionally, such filling of the notch or cutout may be unnecessary, insofar as a housing or other component of the end product covers the notch or cutout when the microphone device is integrated into the end product.

In some cases, testing is implemented after assembly of the end product (e.g., after the integration of the microphone device into the end product). The notch or cutout may be positioned or otherwise configured to be in communication with a speaker of the end product. The testing may thus include detecting whether sound emitted by the speaker is detected by the acoustic sensor device.

The configuration, construction, and other characteristics of the enclosure (e.g., the gasket) of the disclosed modules or devices may vary. For instance, the gasket may or may not have a unitary, or one-piece, construction. In some cases, the gasket may be or include a composite structure or arrangement including a number of different materials.

The configuration, construction, and other characteristics of the directional microphone of the disclosed devices may also vary. For instance, the microphone may or may not include a microelectromechanical system (MEMS) transducer.

Although generally described in connection with microphones, the disclosed acoustic modules having leak detection notches or cutouts may be used in other applications and contexts. For instance, the disclosed the disclosed acoustic modules having leak detection notches or cutouts are useful in connection with accelerometers, gyroscopes, inertial sensors, pressure sensors, gas sensors, etc. The disclosed acoustic modules having leak detection notches or cutouts are described in the context of excitation by sound waves. However, alternative or additional stimuli may be used with the disclosed acoustic modules having leak detection notches or cutouts or sensor devices in other contexts.

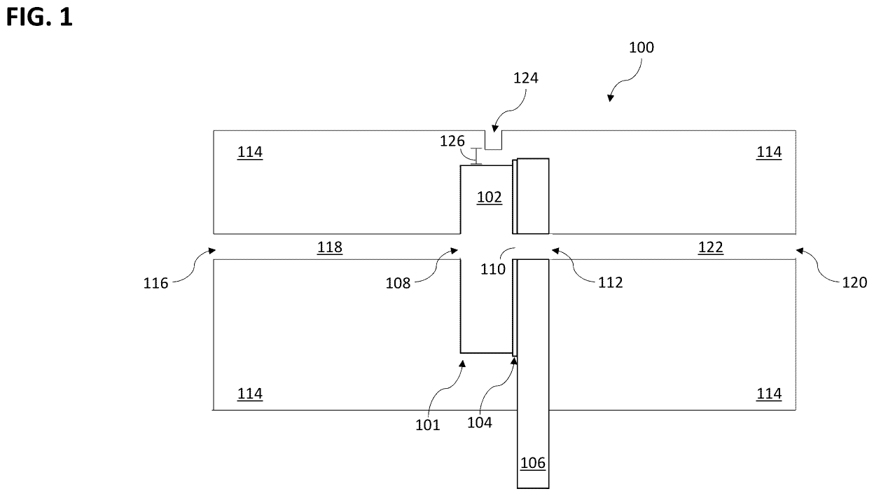

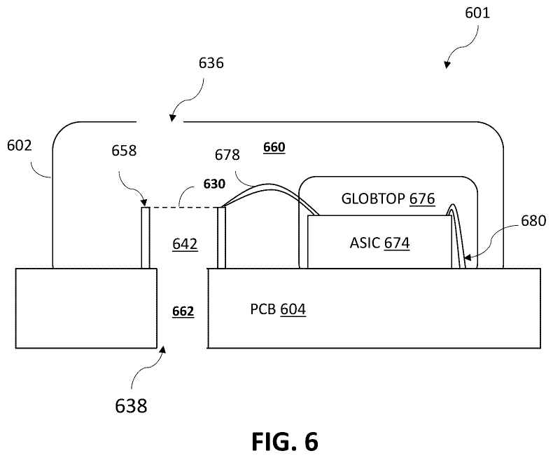

FIG. 1 depicts a cross section of an acoustic sensor module 100 with a built-in leakage detection feature in accordance with one example. The acoustic sensor device 101 is sealed in an enclosure (e.g., a gasket) 114. The acoustic sensor device 101 may be or otherwise include a microphone (e.g., a MEMS microphone), for example. The acoustic sensor device 101 may be configured as a directional acoustic sensor device (e.g., a directional microphone) that includes a transducer and two sound port that may couple opposing sides of the transducer to an ambient environment. The acoustic sensor device 101 may thus be configured to exhibit a directional response or pick-up pattern, such as a dipole or “FIG. 8” pattern, with respect to sound waves traveling in an ambient environment of the acoustic sensor device 101. In other examples, the acoustic sensor device 101 may be configured to exhibit a directional response or pick-up pattern different from a dipole pattern, such as a cardioid pattern or another suitable directional pattern. An example acoustic sensor device that may correspond to the acoustic sensor device 101 is described in more detail below with reference to FIG. 6. In other examples, the acoustic sensor device 101 may be different from the acoustic sensor device of FIG. 6.

The acoustic sensor device 101 includes a lid 102 supported by a printed circuit board (PCB) 104. The acoustic sensor device 101 is further mounted onto a PCB 106 of a final product. The PCB 106 may be a flexible printed circuit board or a hard printed circuit board. The acoustic sensor device 101 has a top sound port 108 embedded in the lid 102, and a bottom side sound port 110 embedded in the PCB 104. The bottom sound port 110 of the acoustic sensor device 101 is coupled to a sound port 112 embedded in the product PCB 106.

The acoustic sensor device 101 is disposed or positioned within or inside of the enclosure 114. The enclosure 114 may be a gasket, and the enclosure 114 is sometimes referred to herein as a “gasket 114” for ease of explanation. The gasket 114 may include any combination of rubber, foam, adhesive, plastic, and/or other materials. Sealing of the acoustic sensor device 101 to the gasket 114 may be ensured through compression, an adhesive, and/or any other technique to ensure proper acoustic seals. The gasket 114 includes a first sound port 116 (also referred to herein as a “front sound port”) configured to couple the ambient air to the top sound port 108 of the acoustic sensor device 101 via an acoustic channel 118. The gasket 114 also includes a second sound port 120 (also referred to herein as a “back sound port”) configured to couple the ambient air to the bottom sound port 112 in the product PCB 106 via an acoustic channel 122.

The gasket 114 includes a notch or cutout 124 configured to enable detection of a leakage path between the top sound port 108 and bottom sound port 110 inside of the gasket 114. The cutout 124 is spaced from the microphone lid 102 by a distance 126. The distance 126 sets the width of the leakage path to be detected. If there is a leakage path between the top sound port 108 and bottom sound port 110, and the width of the leakage path is greater than or equal to the distance 126, the leakage path will couple to the ambient air through the cutout 124. If the width of the leakage path is less than the distance 126, then the leakage path will not couple to the ambient air. For instance, a gap between the acoustic sensor device housing and the gasket of less than a threshold size (e.g., 0.3 mm) may be acceptable. A gap equal to or greater than the threshold size (e.g., 0.3 mm) may be unacceptable, and the distance 126 may be set to be equal to the threshold size to detect gaps that exceed the threshold size. In another example, the cutout 124 may extend through the gasket 114 to reach the lid 102.

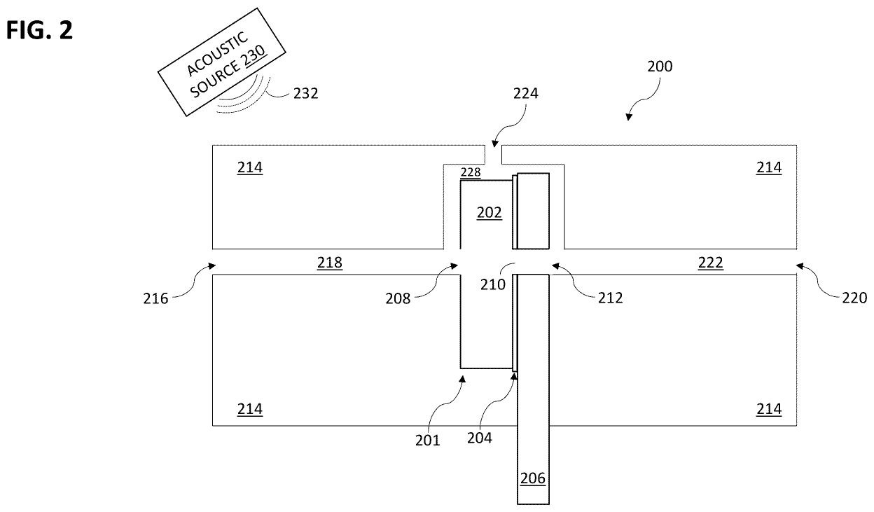

FIG. 2 depicts a cross section of an acoustic sensor module 200 including an enclosure (e.g., a gasket) 214 for an acoustic sensor device 201 with a built-in leakage detection feature in accordance with another example. The acoustic sensor module 200 is similar to the acoustic sensor module 100 of FIG. 1 and includes like-numbered elements with the acoustic sensor module 100 of FIG. 1 that are not described in detail below for the purpose of brevity. The acoustic sensor device 201 is mounted on a product PCB 206 and disposed within or inside the enclosure 214 (sometimes referred to herein is “gasket 214”). The acoustic sensor device 201 has a top sound port 208 embedded in a lid 202 and a bottom sound port 210 embedded in the PCB 204 of the acoustic sensor device 201. The bottom sound port 210 is coupled to a sound port 212 embedded in the product PCB 206. The gasket 214 has a front acoustic channel 218 and a back acoustic channel 222. Unlike in the example of FIG. 1, in gasket 214, there is an unwanted leakage path, or channel, 228 that couples the air from the front channel 218 to the back channel 222. This creates an undesired acoustic path between the top sound port 208 and bottom sound port 210 that can degrade the sensitivity and/or directional of the acoustic sensor device 201. The leakage path 228 may occur due to improper sealing of the gasket 214 to the acoustic sensor device 201.

In order to the detect acoustic leaks, or bad acoustic seals, the front sound port 216 and back sound port 220 would be completely covered or sealed (e.g., by clay). An external sound 232 from an acoustic source 230 is played. The output signal of the acoustic sensor device 201 with the front sound port 216 and back sound port 220 is compared when sealed and when not sealed. If there is a significant attenuation in the acoustic sensor device output when the sound ports 216 and 220 are sealed for the same external sound 232, then the acoustic sensor device is said to be properly sealed. However, with a directional acoustic sensor device 201, if leakage path 228 exists, and the gasket does not have cutout 224, then acoustic sensor device 201 will see a large attenuation in its output for the sealing check method described above. Leakage path 228 would go unnoticed.

However, the presence of cutout 224 ensures that leakage path 228 can be detected. When sound ports 216 and 220 are sealed, and an external sound 232 is played, the sound 232 can couple into acoustic sensor device 201 through the cutout in the gasket 224. In an example, when the same external sound 232 is played when the sound ports 216 and 220 are covered and uncovered, the acoustic sensor device 201 will see less of a difference in sound output level than expected. Thus, the cutout 224 ensures that a leakage path of at least a predetermined width can be detected, ensuring proper performance of the acoustic sensor device 201 and surrounding assembly.

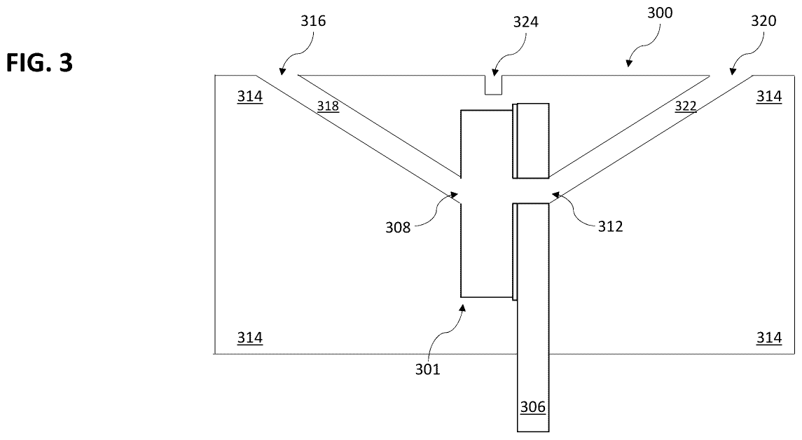

FIG. 3 depicts a cross section of an acoustic sensor module 300 including an enclosure (e.g., a gasket) 314 for an acoustic sensor device 301 with a built-in leakage detection feature in accordance with another example. The acoustic sensor module 300 is similar to the acoustic sensor module 100 of FIG. 1 and includes like-numbered elements with the acoustic sensor module 100 of FIG. 1 that are not described in detail below for the purpose of brevity. The acoustic sensor device 301 is mounted on the product PCB 206 and disposed within gasket 314. The gasket 314 has a cutout 314 for detection of a leakage path between two sound ports of the microphone 301 as described in connection with the above-described examples. In this example, microphone 301 is coupled to bent acoustic channels. The top sound port 308 is coupled to a bent front acoustic channel 318 and the sound port 312 in the product PCB is coupled to a bent back acoustic channel 322. Both the front acoustic channel 318 and back acoustic channel 322 in this embodiment couple to sound ports 316 and 320 of the gasket 314. In this case, the sound ports 316 and 320 are embedded on the same side of gasket 314. This positioning of the ports may make integration into the final product simpler and keep all sound ports on one surface of the end product.

In the above examples, the enclosure (e.g., gasket) may have a one-piece construction in which the microphone can fit inside. In some examples, it may be beneficial for the enclosure (e.g., the gasket) to have a two- or multi-piece construction, which may be useful for ease in assembly, e.g., placing the microphone inside the final gasket.

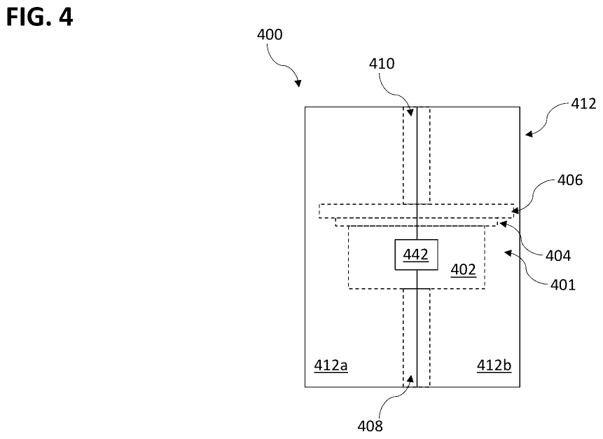

FIG. 4 depicts a top view of an acoustic sensor module 400 having a two-piece enclosure (e.g., gasket) 412 with an embedded leak detection cutout in accordance with one example. The acoustic sensor module 400 is similar to the acoustic sensor module 100 of FIG. 1 and includes like-numbered elements with the acoustic sensor module 100 of FIG. 1 that are not described in detail below for the purpose of brevity. The acoustic sensor module 400 includes an acoustic sensor device 401 which, in turn, includes a lid 402 and a PCB 404. The acoustic sensor device 401 is further supported by a product PCB 406. The acoustic sensor device 401 also includes a top sound port coupled to a front acoustic channel 408 and a bottom sound port coupled to a back acoustic channel 410 through the product PCB 406. The acoustic sensor device 401 and product PCB 406 are enclosed by the gasket 412. The gasket 412 includes two pieces, separated along the length of the acoustic channels 408 and 410. The gasket has a left piece 412a and a right piece 412b. During the assembly of the acoustic sensor module 400, the left piece 412a and right piece 412b of the gasket 412 may be brought together through compression, an adhesive, a clamp, and/or another technique to ensure a proper acoustic seal of the acoustic sensor device 401 with the front acoustic channel 408 and back acoustic channel 410. When the left piece 412a and the right piece 412b of the gasket 412 are brought together to encapsulate microphone 401, the pieces also create a cutout 414 similar to those described in connection with FIGS. 1-3.

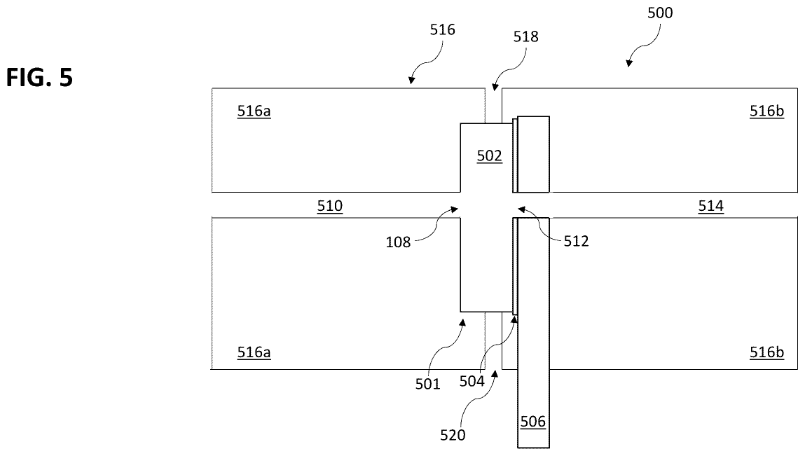

FIG. 5 depicts a cross-sectional view of an acoustic sensor module 500 having a two-piece enclosure (e.g., gasket) 516 with an embedded leak detection cutout in accordance with another example. The acoustic sensor module 500 is similar to the acoustic sensor module 400 of FIG. 4 and includes like-numbered elements with the acoustic sensor module 100 of FIG. 1 that are not described in detail below for the purpose of brevity. The acoustic sensor module 500 includes an acoustic sensor device 501 which, in turn, includes a lid 502 and a PCB 504. The acoustic sensor device 501 is further supported by a product PCB 506. The acoustic sensor device 501 also includes a top sound port coupled to a front acoustic channel 510 and a bottom sound port coupled to a back acoustic channel 514 through the product PCB 506. The microphone 501 and product PCB 506 are enclosed by the gasket 516. The gasket 516 includes two pieces. The gasket 516 includes a front piece 516a which creates the front acoustic channel 510 with the acoustic sensor device 501. Additionally, the gasket 516 includes a back piece 516b that creates the back acoustic channel 514 with the microphone 501. When the front piece 516a and the back piece 516b of the gasket 516 are brought together to encapsulate the acoustic sensor device 501, the pieces also create a cutout 518 similar to those described in connection with FIGS. 1-4. In some examples, the gasket 516 may be configured in such a way that a cutout 520 below the acoustic sensor device 501 is created that is similar in nature to cutout 518.

FIG. 6 is a cross-sectional, schematic view of an acoustic sensor device 610, according to an example. The acoustic sensor device 601 may be a microphone, for example. In various examples, the acoustic sensor device 601 corresponds to the acoustic sensor devices 101, 201, 301, 401, 501 described above. The acoustic sensor device 601 includes like-numbered elements that may be the same as or similar to the corresponding elements of the acoustic sensor devices 101, 201, 301, 401, 501 described above. In other examples, however, the acoustic sensor devices 101, 201, 301, 401, 501 may be different from the acoustic sensor device 601.

The acoustic sensor device 601 includes a transducer 658. The transducer 658 may be a MEMS transducer, for example. In other examples, the transducer 658 may comprise a suitable transducer other than a MEMS transducer. The transducer 658 may be attached to or otherwise supported by a PCB or other substrate 604 (generally referred to herein as “PCB 604”). The PCB 604 may comprise one or more layers. In an example in which the PCB 604 comprises multiple layers, respective ones of the multiple layers may be separated from one another by a dielectric material. The one or more layers of the PCB 604 may include conductive traces that may route electrical signals in the PCB 604. The acoustic sensor device 601 may also include a lid or other enclosure 602 (generally referred to herein as “lid 602”). The lid 602 may be placed over the PCB 604 to enclose the components of the acoustic sensor device 601 mounted on or otherwise attached to the PCB 604. The lid 602 may be composed of, or otherwise include, a metal, plastic, ceramic, or other material. The lid 602 and the PCB 604 may form a package or housing of the acoustic sensor device 601. In other examples, a package or housing of the acoustic sensor device 601 may be formed in other suitable manners.

The transducer 658 may include a sensing element 630 positioned over a cavity 642. The cavity 642 may be formed in the transducer 658 through various microfabrication practices including, for instance, deep reactive ion etching (DRIE). The sensing element 630 may comprise a diaphragm, for example. The sensing element 630 includes a first side that faces outwards with respect to the cavity 642 and a second side that faces the cavity 642. In an example, the sensing element 630 may comprise a cantilever diaphragm structure that is attached on one end and is free to move on the other end. In another example, the sensing element 630 may comprise another suitable structure, such as a fixed-fixed structure that is fixed on more than two sides, such as a diaphragm that is fixed or anchored on all sides around the perimeter.

The acoustic sensor device 601 may include a first sound port 636 formed in the lid 602 and a second sound port 638 formed in the PCB 604. A first air volume 660 may be formed in the package of the acoustic sensor device 602 between the PCB 604 and the lid 602 and may be configured to be exposed to the ambient environment via the first sound port 636. A second air volume 662 may comprise the cavity 642 in the transducer 658 and may be configured to be exposed to the ambient environment via the second sound port 638. The sensing element 630 may thus have two opposing sides exposed to the ambient environment, and may sense a pressure gradient between the opposing sides of the sensing element 630 exposed to the ambient environment. Because the sensing element 630 of the transducer 658 has two opposing sides that are exposed to the ambient environment, and thus the transducer 658 senses the pressure gradient between the opposing sides of the sensing element 630 exposed to the ambient environment, the transducer 658 may exhibit a directional polar pattern. For example, the transducer 658 may exhibit a dipole, or FIG. 8, polar pattern.

The acoustic sensor device 601 may also include an ASIC 674. The ASIC 674 may be mounted on or otherwise attached to the PCB 604. The ASIC 674 may be covered by a globtop 676. The ASIC 674 may be electrically coupled to the transducer 608. For example, the transducer 608 and ASIC 674 may be electrically connected by wire bonds 678, either directly to each other, or via traces on the PCB 604. The ASIC 674 may also be electrically connected to the PCB 604 by wire bonds 680. In other examples, the transducer 658 and the ASIC 674 may be attached and/or electrically coupled using other suitable methods. For example, the transducer 658 may be attached to the PCB 604 using flip chip technology. The ASIC 674 may be configured to read out electrical signals generated by the transducer 658 based on movement of the sensing element 630 and to amplify the signals.

In various examples, the acoustic sensor device 601 may be encapsulated in an enclosure (e.g., a gasket) for integration into an end product device. The enclosure may include a first sound port configured to couple a first (top) side of the transducer 658 to an embodiment environment via the first sound port 636 coupled to a first acoustic channel formed in the enclosure. The enclosure may also include a second sound port configured to couple a second (bottom) side of the transducer 658 to the embodiment environment via the second sound port 638 coupled to a second acoustic channel formed in the enclosure. The enclosure may additionally include one or more notches or cutouts configured to enable detection of a leakage path, within the enclosure, between the first sound port formed in the enclosure and the second sound port formed in the enclosure, around an outside of the acoustic sensor device 601.

Examples are described in which an enclosure encapsulating and sealing an acoustic sensor device (e.g., microphone) includes one or more notches or cutouts configured to enable detection of one or more leakage paths within the enclosure when the acoustic sensor device is encapsulated in the enclosure. The enclosure may include a gasket configured to seal the acoustic sensor device by one or both of i) compression between the gasket and the acoustic sensor device and ii) an adhesive between the gasket and the acoustic sensor device. The one or more notches or cutouts in the enclosure may be used to test for the presence of one or more leakage paths between two sound ports of an acoustic sensor device, for example. The notch or cutout may be configured to extend into the enclosure such that the notch or cutout in the enclosure is spaced from a package of the acoustic sensor device by a set distance. The set distance may be configured to enable detection of a leakage path that is equal to or greater than a length of the set distance. For example, the set distance may be configured for detection of a gap between the acoustic sensor device housing and the enclosure (e.g., the gasket) of more than a minimum unacceptable gap that would unacceptably degrade performance of the acoustic sensor device. In another example, the notch or cutout may be configured to extend through the enclosure to reach a package of the acoustic sensor device. These and other configurations described herein may enable detection of leakage paths, within the enclosure, between two sound ports formed in the enclosure to provide couplings of opposing sides of a transducer of a directional acoustic sensor device to an ambient environment of the acoustic sensor device. Without the notch or cutout in the enclosure, such internal leakage paths may remain undetected and performance (e.g., directionality) of the acoustic sensor device may be negatively affected when the sealed acoustic sensor device is integrated into an end product.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. An acoustic module, comprising:
an acoustic sensor device including a transducer; and
an enclosure configured to encapsulate and seal the acoustic sensor device within the enclosure, the enclosure including
a first sound port configured to couple a first side of the transducer to an embodiment environment via a first acoustic channel formed in the enclosure,
a second sound port configured to couple a second side of the transducer to the embodiment environment via a second acoustic channel formed in the enclosure, and
a notch formed on a surface of the enclosure, the notch configured to enable detection of a leakage path, within the enclosure, between the first sound port and the second sound port around an outside of the acoustic sensor device.

2. The acoustic sensor module of claim 1, wherein the notch is configured to extend into the enclosure such that the notch in the enclosure is spaced from a package of the acoustic sensor device by a set distance.

3. The acoustic sensor module of claim 2, wherein the set distance is configured to enable detection of a leakage path that is equal to or greater than a length of the set distance.

4. The acoustic sensor module of claim 1, wherein the notch is configured to extend through the enclosure to reach a package of the acoustic sensor device.

5. The acoustic sensor module of claim 1, wherein:
the notch is a first notch formed on a first side of the enclosure and configured to enable detection of the leakage path around a first side of the acoustic sensor device; and
the enclosure further includes a second notch formed on a second side of the enclosure and configured to enable detection of another leakage path around a second side of the acoustic sensor device.

6. The acoustic sensor module of claim 1, wherein the first acoustic channel and the second acoustic channel are bent and diagonally disposed within the enclosure such that the first sound port and the second sound port are formed on a same side of the enclosure.

7. The acoustic sensor module of claim 1, wherein the enclosure comprises a gasket.

8. The acoustic sensor module of claim 7, wherein the gasket is configured to seal the acoustic sensor device by one or both of i) compression between the gasket and the acoustic sensor device and ii) an adhesive between the gasket and the acoustic sensor device.

9. The acoustic sensor module of claim 7, wherein the gasket includes a combination of one or more of a rubber material, a foam material, an adhesive, or plastic.

10. The acoustic sensor module of claim 7, wherein the notch comprises a cutout in the gasket.

11. The acoustic sensor module of claim 7, wherein:
the gasket comprises two separate gasket parts; and
the notch is formed at a junction between the two separate gasket parts.

12. The acoustic sensor module of claim 11, wherein:
the notch is a first notch formed at the junction between the two separate gasket parts on a first side of the acoustic sensor device and configured to enable detection of the leakage path around the first side of the acoustic sensor device; and
the enclosure further comprises a second notch formed at the junction between the two separate gasket parts on a second side of the acoustic sensor device and configured to enable detection of another leakage path around the second side of the acoustic sensor device.

13. The acoustic sensor module of claim 1, wherein the notch is configured to be filled after leak detection is performed and before the acoustic sensor module is integrated into an end product device.

14. The acoustic sensor module of claim 1, wherein the transducer comprises a microelectromechanical system (MEMS) transducer.

15. The acoustic sensor module of claim 1, wherein the acoustic sensor device comprises a microelectromechanical system (MEMS) microphone.

16. An acoustic module, comprising:
an acoustic sensor device including a transducer; and
a gasket configured to encapsulate and seal the acoustic sensor device within the gasket, the gasket including
a first sound port configured to couple a first side of the transducer to an embodiment environment via a first acoustic channel formed in the gasket,
a second sound port configured to couple a second side of the transducer to an embodiment environment via a second acoustic channel formed in the gasket, and
one or more notches formed on a surface of the gasket, the one or more notches configured to enable detection of one or more leakage paths, within the gasket, between the first sound port and the second sound port around one or more sides of the acoustic sensor device.

17. The acoustic sensor module of claim 16, wherein the one or more notches comprise one or more cutouts in the gasket.

18. The acoustic sensor module of claim 16, wherein the one or more notches are configured to extend into the gasket such that the one or more notches in the gasket are spaced from a package of the acoustic sensor device by a set distance, wherein the set distance is configured to enable detection of a leakage path that is equal to or greater than a length of the set distance.

19. The acoustic sensor module of claim 16, wherein:
the gasket comprises two separate gasket parts; and
the one or more notches are formed at a junction between the two separate gasket parts.

20. The acoustic sensor module of claim 19, wherein the one or more notches include:
a first notch formed at the junction between the two separate gasket parts on a first side of the acoustic sensor device and configured to enable detection of a first leakage path around the first side of the acoustic sensor device; and
a second notch formed at the junction between the two separate gasket parts on a second side of the acoustic sensor device and configured to enable detection of a second leakage path around the second side of the acoustic sensor device.
